(19) United States
(12) Patent Application Publication
(10) Pub. No.: US 2009/0159752 A1
(43) Pub. Date: Jun. 25, 2009

(54) Spreader bar lateral kite control

(75) Inventor: John Maldonado, Santa Cruz, CA (US)

Correspondence Address: OLIFF & BERRIDGE, PLC, P.O. BOX 320850, ALEXANDRIA, VA, 22320-4850, US

(73) Assignee: SIDEWINDER GEAR LLC, Santa Cruz, CA (US)

(21) Appl. No.: 12/314,371

(22) Filed: Dec. 9, 2008

Related U.S. Application Data
(60) Provisional application No. 61/006,103, filed on Dec. 19, 2007.

(51) Int. Cl. B64C 31/06

(52) U.S. Cl. 244/155 A

(57) ABSTRACT

A spreader bar lateral kite control has a moveable kite control member, which moves laterally across the spreader bar and allows for changing a direction of kite pull with respect to a user's body. The spreader bar is spaced away from the user's body in a center and is attached to the user's harness at the ends. The distance from the kite control to the boarder may change from a long distance d₁ to a shorter distance d₂ when the control moves to a lateral position.

### BACKGROUND OF THE INVENTION

### Field of the Invention

This invention relates to the field of kite towing of persons engaged in sports where kites pull the individual. More particularly, the invention relates to the field of kiteboarding and kitesurfing. The invention relates to control of the kite by a kiteboarder.

In kiteboarding, the kiteboarder wears a harness around his body, which is connected to a spreader bar. The spreader bar functions to spread the load produced by the pull of the kite from the center of a harness to the sides, thereby producing pull on both sides of the wearer, and less body stress which would otherwise be due to pulling on a single point such as the middle of a flexible belt. The spreader bar is preferably made of a metal which provides a secure attachment to a cloth harness. Prior art spreader bars fixably mount a hook or other means of attachment of a kite control assembly to one place on the spreader bar. FIG. 8 shows an example of a prior art spreader bar having a forward facing hook, which may extend several inches to the front of the spreader bar. The hook is for attachment to a kite control apparatus, which typically includes a control bar.

The problem with prior art is that by using only a fixed location on the spreader bar, the pull of the kite is always at the same location on a kiteboarder's body. Therefore, if the kite changes direction with respect to the user's body, or vice versa, the forces on the spreader bar will pull the kiteboarder's body in line with the pull of the kite lines. When a boarder is following a kite and not moving laterally with respect to the kite, the pull is directly away from the body of the boarder. However, when the boarder chooses to move his body in a direction, which is not in line with the pull of the kite, he must strain and twist his body in order to tack the board at an angle with respect to the kite pull. The kite pull in this condition actually pulls sideways against the boarder, but the location of the pull is at the center of the boarder's body, and not at a side. In the case of the prior art spreader bar with an extended hook, the situation is even more difficult because the distance of the hook from the bar acts as a leaver arm, that actually increases the twisting force that the boarders body experiences when attempting to travel laterally with respect to the kite pull. The greater the distance of the hook from the spreader bar, the greater the twisting torque on the boarders body. The prior art stationary hook only allows limited movement of the kite with respect to the boarder's body. This limits the rider's performance and requires twisting of the body to obtain the desired performance from the kite. As a consequence, greater effort is required from the boarder to hold the kite to the side, and to twist his body and legs in order to maintain a tact angle with respect to a kite.

### SUMMARY

In this invention, a spreader bar is provided which has harness attachments at both ends. The central portion of the spreader bar of this invention is away from the boarder's body and allows the point where the kite pull is concentrated to move across the bar from right to left and towards the sides of the boarder. As the kite pull direction moves to one side, the boarder's body can face in a different direction without being subject to high torque produced by pulling at the center of the body, or even greater torque produced with there is a hook which extends outwardly as in the prior art spreader bar. The kite control moves across the spreader bar to change pull direction with respect to the boarder's body. The kite can be in more positions in the “wind window” which improves performance of the kite.

In this invention, the spreader bar center is placed outwardly from the boarder's body and is preferably in a curved shape or a shape where the center of the bar is further away from the user's body than the sides. More preferably, the spreader bar will have an actuate shape. A roller on the kite control may be provided to allow the kite line connection to the spreader bar to move freely from one side of the bar to another while the boarder is either tacking at an angle or changing tack angle directions.

In conventional spreader bars having central attachments, the boarder always experiences kite pull at the center. Therefore, boarders are accustomed to a center pull and this invention can accommodate this custom because preferably the center of the spreader bar is further from the boarder's body than the sides of the spreader bar. The sides are near the point of attachment to the harness.

The spreader bar may also include a spreader body bar body plate connected to each end of the spreader bar. This body plate provides additional support in the abdominal area of a kiteboarder and rigidity. This rigidity, however, may not be required when the spreader bar of this invention is of sufficient strength that the harness attachments will not move or bend with respect to the boarder's body when the kite pulls on the spreader bar. On the other hand, if the spreader bar is somewhat flexible, then the spreader bar body plate will reinforce the attachments to the harness and prevent bending or movement.

In order to further provide centering of the roller connection to the center of the spreader bar of this invention, a spring may be included between a center of the spreader bar body plate and the kite control member, which moves across the spreader bar. As the kite control moves laterally, the spring will be extended and the force returning it to the center may be increased. The spring urges the hook to its center or “upright” position which allows the rider to easily hook and unhook the apparatus while riding.

### BRIEF DESCRIPTION OF THE DRAWINGS

FIG. 1 shows a spreader bar and moveable kite attachment.

FIG. 2 shows a spreader bar with moveable kite attachments including a spreader bar body plate.

FIG. 3 shows a spreader bar combination of FIG. 2 with the alternate position of the kite control member shown in phantom lines.

FIG. 4 shows another embodiment of the invention, which has rollers on both sides of the spreader bar and a hook for attachment to a kite and control bar.

FIG. 5 shows a cross-sectional view of the moveable kite control of FIG. 4.

FIG. 6 shows the control of FIG. 4 which also includes a return spring.

FIG. 7 shows another embodiment of the two roller device of FIG. 4 which has a bent circular cross bar section hook.

FIG. 8 shows a prior art spreader bar having a hook for attachment to a kite control bar and kite.

### DETAILED DESCRIPTION OF EMBODIMENTS

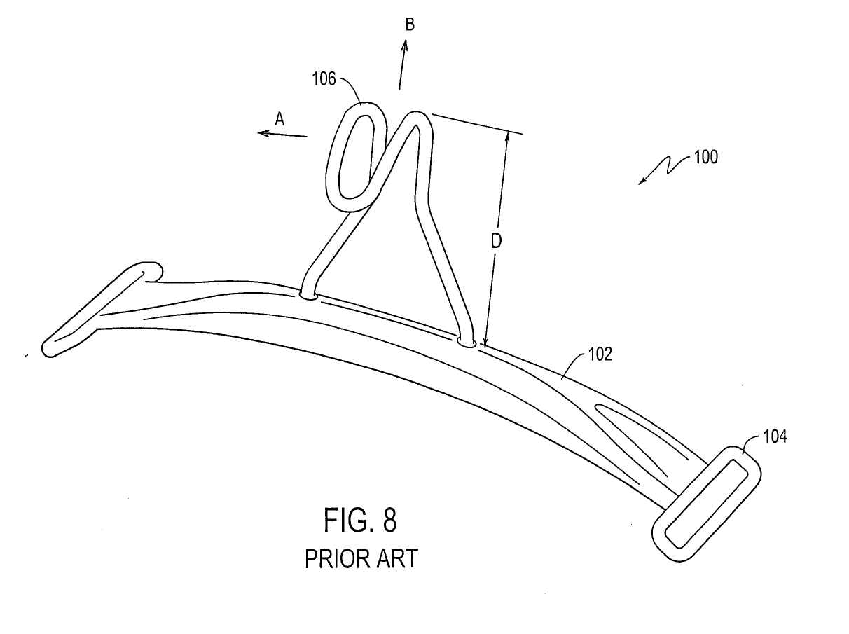

FIG. 8 shows a prior art spreader bar assembly 100. The spreader bar 102 is a solid peace extending across the abdomen of a kiteboarder. The spreader bar 102 is attached to a body harness (not shown) at opening 104. In the center and rigidly fixed to the spreader bar 102 is a hook member 106 which provides for attachment of the spreader bar to a kite control apparatus including a kite control bar (not shown). The hook 106 extends a distance D away from the center of the spreader bar 102. If a kite pull is in a direction A, then the kiteboarder's body will be twisted to the side in the direction of arrow A and a torque proportional to the kite pull in direction A times the distance D will twist the boarder's body. On the other hand, when the kite pull is in the direction of arrow B, there is no torque or twist on the boarder's body. It is easily seen that in the prior art the pull of the kite always forces the spreader bar assembly hook 106 to point in the direction of the pull which is approximately perpendicular to the direction of the spreader bar 102.

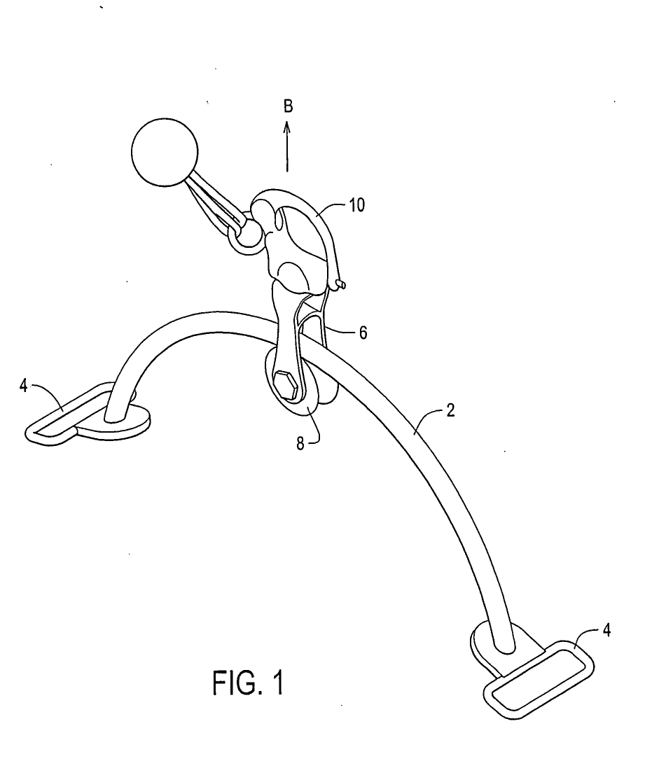

FIG. 1 shows a first embodiment of the invention, which includes a spreader bar 2 extending from harness attachment openings 4. The spreader bar 2 is preferably circular in cross-section and may be an arcuate or semicircular shape as shown in FIG. 1. Attached to the spreader bar 2 is a kite control 6. A roller 8 of the kite control 6 allows kite control 6 to move laterally from side to side across the spreader bar 2. In the embodiment shown, there is a snap shackle 10, which is used to release the kite line and kite control bar in the case of an emergency. The roller 8 necessarily rides on the inside of the spreader bar 2 because of the pull against the shackle in the direction of arrow B. As shown in FIG. 1, the direction of arrow B is away from an approximate center of the kite bar 2 and due to the location of harness attachment 4 pulls away from the center of the boarder's body.

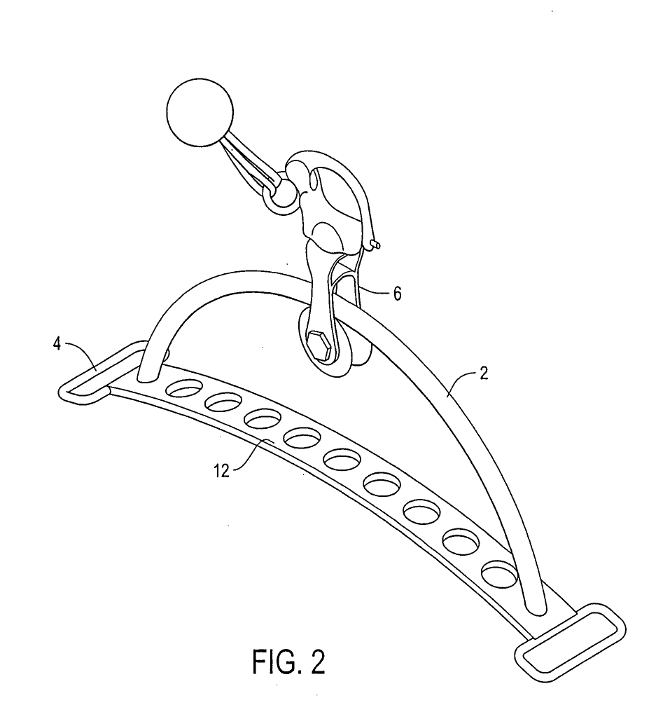

FIG. 2 shows an alternative embodiment of the spreader bar assembly, which includes a spreader bar body plate 12. The spreader bar body plate 12 may serve two functions. The first function is to provide rigidity to the spreader bar 2, which will prevent bending of spreader bar 2, which would change the position of harness attachments 4 on the boarder's harness. Secondly, the spreader bar plate 12 provides a stiffener across the abdomen of the kiteboarder and support for the kiteboarder in the same manner of the spreader bar 102 shown in FIG. 8.

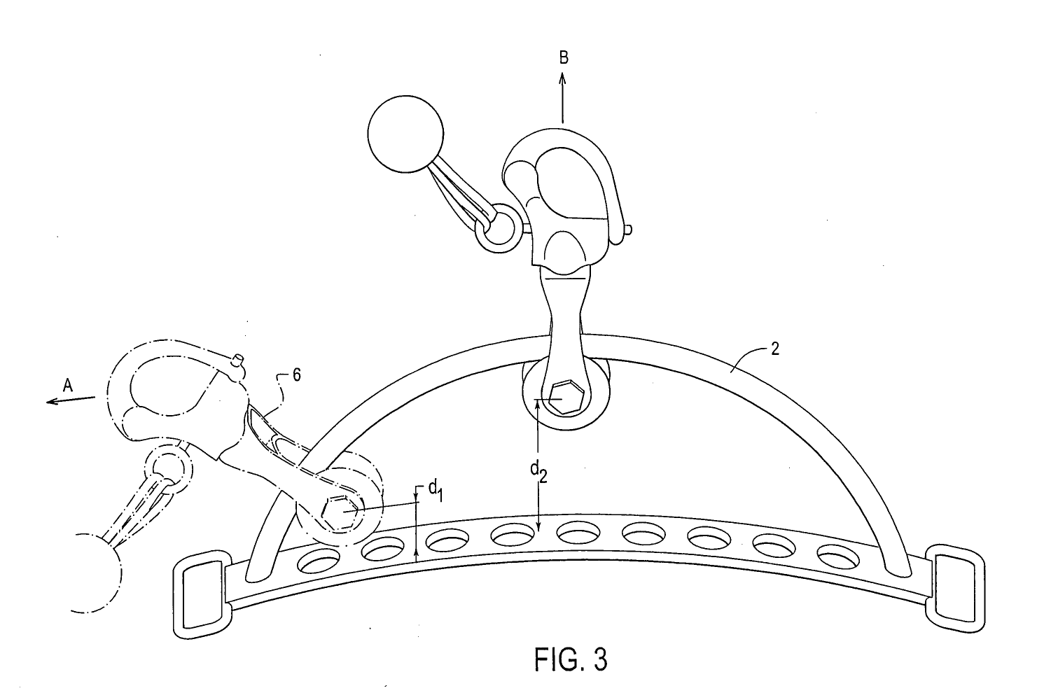

FIG. 3 shows the spreader bar assembly of FIG. 2, which demonstrates in phantom lines the alternate lateral location of the moveable kite control 6. In FIG. 3, when kite pull is in the direction of arrow A, the kite control moves to the phantom line position 6. In this position, the distance from the user's body of the location of the kite control is a distance d₁, which is less than the distance d₂ when the pull is in the direction of the arrow B. In FIG. 8, distance D is fixed. Unlike the prior art of FIG. 8, in this invention, the distance d₂ can be reduced to a distance d₁ lateral direction such as in the direction of arrow A. This reduces torque or twisting motion on the boarder's body when the kite pull direction moves to a lateral direction. When the control moves from the center position to the lateral side position, it also moves the force of the pull to one side of the spreader bar 2 thereby allowing the boarder to face in a different direction than the direction of the kite pull with greater ease. This allows the boarder to have better control of the board with respect to the water because the less angular twist of the body that would be produced by a rigid extending hook as shown in the prior art FIG. 8.

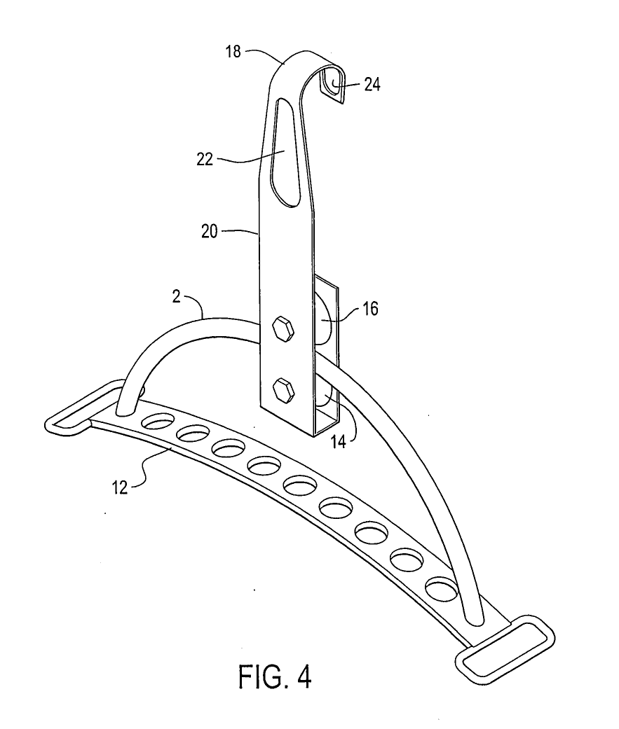

FIG. 4 shows an alternative embodiment, which includes the spreader bar 2 and the spreader bar body plate 12 as shown in FIG. 2. In FIG. 4, there are two rollers 14 and 16, which lie on each side of the spreader bar 12. The two roller control may also be used with FIG. 1. During operation, the primary pull of the kite is against the roller 14. However, roller 16 provides for ease of movement of the control across the bar under control of the kiteboarder who may choose to move the control bar to one side or the other by hand movements and moving with respect to kite pull. A hook 18 connects to the kite control bar and kite control and kite in the usual manner. In this embodiment, the plate 20 is bent in a U shape to accommodate the two rollers 14 and 16. Holes 22 and 24 reduce weight.

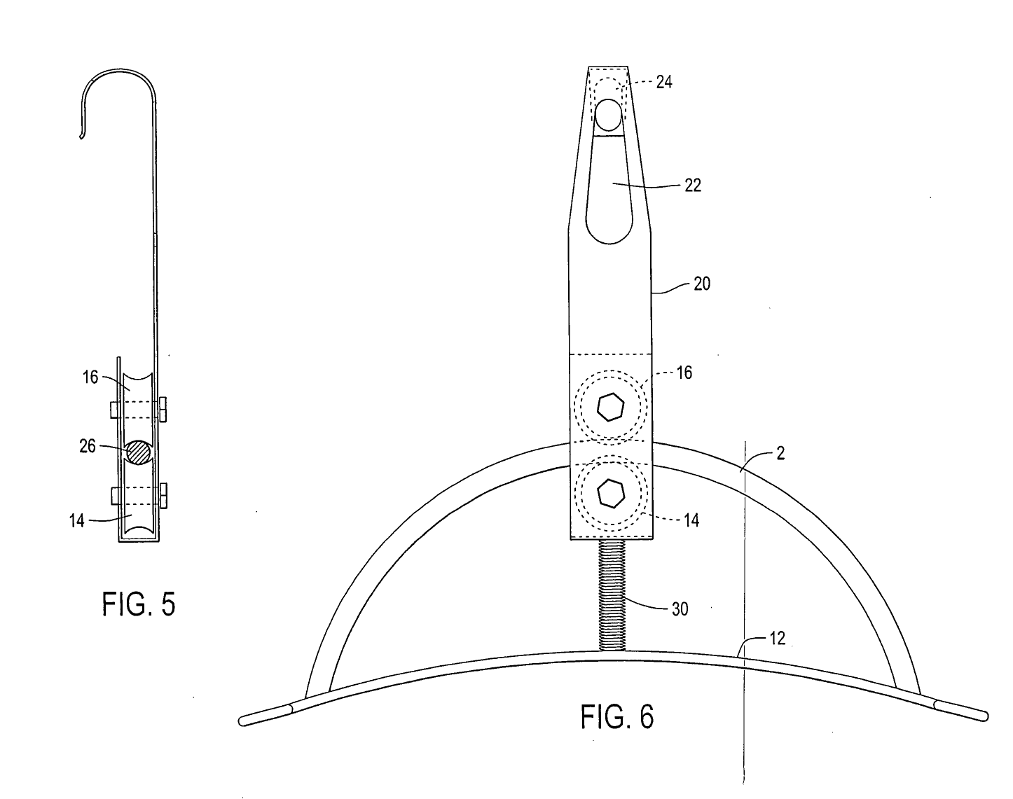

In FIG. 5 there is shown a cross-sectional view of the double roller moveable control of FIG. 4. Here the spreader bar 26 is shown as circular.

In FIG. 6 there is shown an embodiment of the double roller control member and kite bar of FIG. 4. In FIG. 6 however, there is also provided a spring 30. The spring 30 is connected to the roller bar U shaped plate 20 at an end, which extends toward the body of the body, or as shown in FIGS. 4 and 6 toward the spreader bar body plate 12. Spring 30 is connected to the center of the body plate 12 and the spring extends in length when the control is moved to one side or the other. The function of the spring is to urge the control back towards the center and stabilize the control at the center during kiteboarding. The spring 30 may also be used with a single roller as in FIG. 2.

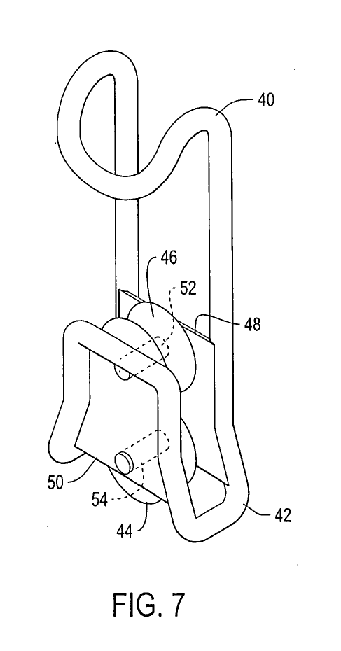

The hook can also be made with other configurations, such as a bent metal bar as shown in FIG. 7. The metal bar can be configured to hold the pulleys as shown in FIG. 7. The hook portion 40 is a circular cross sectional bent rod which has a rearward extension 42 which forms a “U” shape to hold rollers 44 and 46. Plates 48 and 50 are attached to the “U” shaped rear extension 42, preferably by welding. Rollers 44 and 46 are attached to plates 48 and 50 by shafts 52 and 54. The rearward extension 42 is flared which allows movement of the rollers 44 and allows shortening of overall lengths of the hook and control.

While the application has been described in detail herein in accord with certain preferred embodiments thereof, many modifications and changes therein may be effected by those skilled in the art. Accordingly, it is intended by the appended claims to cover all such modifications and changes as fall within the true spirit and scope of the invention.

What is claimed is:

1. A spreader bar lateral kite control apparatus comprising in combination:
a spreader bar having a harness attachment at each end, and spaced away from a user in a center;
a kite control moveably connected to the spreader bar; and
wherein the kite control moves laterally across the spreader bar and allows for changing a direction of kite pull with respect to a user's body between a forward position to a lateral position.

2. The apparatus according to claim 1, further comprising a spreader bar body plate connected at each end of the spreader bar.

3. The apparatus according to claim 1, further comprising a snap shackle connected to the kite control.

4. The apparatus according to claim 1, further comprising a hook connected to the roller.

5. The apparatus according to claim 1, wherein the spacing away from the user allows the kite control member to move further away from the user's body when the pull is straight ahead than when in the lateral position.

6. The apparatus according to claim 2, wherein the spreader bar has an arcuate shape.

7. The apparatus according to claim 9, wherein the arcuate shaped spreader bar and the spreader bar body plate form a “D” shape.

8. The apparatus according to claim 1, further comprising at least one roller, which moves across the spreader bar.

8. The apparatus according to claim 1, wherein the spreader bar is semi-circular in cross-section.

10. The apparatus according to claim 1 wherein the spreader bar has an arcuate shape.

11. The apparatus according to claim 1, wherein the kite control further comprises at least one roller which moves across the spreader bar to a lateral position when the direction of kite pull is changed to a side.

12. The apparatus according to claim 3, wherein there are two rollers, one on each side of the spreader bar.

13. The apparatus according to claim 12, further comprising a return spring connected to the body plate and to the control member.
